(19) United States
(12) Patent Application Publication
(10) Pub. No.: US 2025/0091909 A1
(43) Pub. Date: Mar. 20, 2025

(54) DESALINATION SYSTEM AND METHOD FOR DESALINATION OF WATER

(71) Applicant: KING FAHD UNIVERSITY OF PETROLEUM AND MINERALS, Dhahran (SA)

(72) Inventors: Awad Bin Saud ALQUAITY, Dhahran (SA); Muhammad TALHA, Dhahran (SA); Elyas Abdulwahab Mohammed AL-MUDHHI, Dhahran (SA); Zaid Jassim ALZAID, Dhahran (SA); Mohammed Musallam Mohammed AL-RASHDI, Dhahran (SA); Alwaleed Ibrahim Ali ALQAHTANI, Dhahran (SA)

(73) Assignee: KING FAHD UNIVERSITY OF PETROLEUM AND MINERALS, Dhahran (SA)

(21) Appl. No.: 18/469,942

(22) Filed: Sep. 19, 2023

(51) Int. Cl. C02F 1/36; C02F 103/08

(52) U.S. Cl. CPC C02F 1/36; C02F 2103/08; C02F 2201/002; C02F 2301/04

(57) ABSTRACT

A system and a method for desalination of water is provided. The desalination system includes an ultrasonic chamber to store saline water, an ultrasonic transducer disposed within the ultrasonic chamber, and a collection chamber coupled to the ultrasonic chamber. The ultrasonic transducer generates an aerosol including water particles from the saline water. A vertical distance between a lower region and an upper region of the ultrasonic chamber is above a pre-determined threshold value so that an average size of the water particles of the aerosol is reduced by gravity to 5 μm or less. A fan is provided to transfer the aerosol from the upper region of the ultrasonic chamber to the collection chamber. The collection chamber is configured such that the water particles in the aerosol condense to form liquid water in the collection chamber, which has a lower salt concentration than the saline water.

### BACKGROUND

### Technical Field

The present disclosure is directed to a desalination system, and more particularly, relates to an ultrasonic desalination system and a method of water desalination using the ultrasonic desalination system.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The need to remove salts from the seawater is increasing day by day as fresh water sources are depleting rapidly due to a rapid increase in the overall world population. Most common desalination methods are either thermal-based methods or membrane-based methods. The commercial thermal desalination systems include, multi-effect desalination (MED), multistage flashing (MSF) and vapor compression distillation (VCD). The aforementioned thermal desalination systems require a large amount of thermal energy to produce results, which make them extremely energy intensive. Further, the thermal systems have a huge footprint, which are impractical to be employed in compact spaces. The thermal system suffers from heat losses which impacts their efficiency. Alternatively, the commercially available non-thermal systems are membrane-based like reverse osmosis (RO) system. Membrane-based systems have a major drawback as membrane-based systems may only work efficiently when the membrane is in good condition. The efficiency of an RO system declines as the membrane gets clogged up by the salt collecting in the membrane. Sea water damages the membrane rapidly, thereby subjecting the system to frequent maintenance and added costs. A membrane-based system produces a lot of waste in the form of waste water and other physical waste components.

US20210171366A1 discloses a desalination system wherein an aerosol of seawater particles is generated by ultrasound waves and conveyed through a charged conduit that separates electrically charged aerosolized particles from neutrally charged aerosolized particles that are then condensed to have a lower salinity. However, having multiple elements such as deflection plate and separation conduit makes the desalination system more complex to design and manufacture.

CN103693700B discloses a desalination system in which sea water is atomized and mixed with air before entering an evaporator chamber and absorbing microwave radiation heat to evaporate and vaporize. Water vapors will then condense on an arc-shaped plate. This process is essentially distillation and thus requires thermal energy for a phase change. Ultrasonication is used as a pre-treatment for distillation. However, the aforementioned system requires large amounts of thermal energy, and the microwave radiation makes the system more complex and less energy efficient.

CN213085509U discloses a desalination system in which an atomized liquid generated in an atomizing water tank is driven into a vortex evaporation chamber through a pressurizing fan, before being heated and evaporated in a vortex evaporation chamber and then condensed in a condensing chamber. Similarly, this is also a distillation process, the heating and the pressurizing fan require large amounts of external energy input. This extra energy makes the process less energy-efficient and unsustainable.

Each of the aforementioned patent documents suffers from one or more drawbacks hindering their adoption. Therefore, a need arises for a better and more sustainable water desalination system. Accordingly, it is one object of the present disclosure to provide methods and systems for water desalination using ultrasonic acoustic technology which has a small footprint, a high energy efficiency, and portability, and is easy to operate.

### SUMMARY

In an exemplary embodiment, a desalination system is disclosed. The desalination system includes an ultrasonic chamber configured to receive saline water in a lower region of the ultrasonic chamber, and an ultrasonic transducer located in the lower region of the ultrasonic chamber. The ultrasonic transducer is configured to generate an aerosol including water particles from the saline water. The desalination system further includes a collection chamber configured to be in fluid communication with an upper region of the ultrasonic chamber. The desalination system further includes a fan configured to transfer the aerosol from the upper regions of the ultrasonic chamber to the collection chamber. The lower region of the ultrasonic chamber and the upper region of the ultrasonic chamber have a vertical distance above a pre-determined threshold value so that, in the upper region of the ultrasonic chamber, an average size of the water particles of the aerosol is reduced by gravity to 5 micrometers (μm) or less. The collection chamber is configured such that the water particles in the aerosol are configured to condense to form liquid water in the collection chamber. Further, the liquid water has a lower salt concentration than the saline water.

In some embodiments, the water particles in the aerosol are configured to condense to form the liquid water, which is collected by the collection chamber, with no additional separation process to remove salts from the water particles before the water particles condense to form the liquid water.

In some embodiments, the additional separation process includes an energy input of heat, vortex or electrical charges.

In some embodiments, the fan is configured to continue operation, after the ultrasonic transducer is turned off, to prevent water particles with an average size of larger than 5 μm from entering the collection chamber.

In some embodiments, the collection chamber is positioned above the upper region of the ultrasonic chamber.

In some embodiments, the collection chamber is positioned on a side of the upper region of the ultrasonic chamber.

In some embodiments, the ultrasonic chamber has a slanted top having a lower end towards the collection chamber.

In some embodiments, an upper region of the collection chamber is dome-shaped so that the water particles in the aerosol are configured to condense to form the liquid water on the upper region of the collection chamber.

In some embodiments, the desalination system further includes a conduit connecting the upper region of the ultrasonic chamber to the upper region of the collection chamber.

In some embodiments, the collection chamber is detachable from the ultrasonic chamber.

In some embodiments, the liquid water has a salt concentration at least 60% lower than the saline water.

In some embodiments, the lower region of the ultrasonic chamber and the upper region of the ultrasonic chamber are configured so that, in the upper region of the ultrasonic chamber, the average size of the water particles of the aerosol is reduced by gravity to 2.5 μm or less.

In another exemplary embodiment, a method of water desalination is disclosed. The method includes generating an aerosol from saline water by an ultrasonic transducer located in a lower region of an ultrasonic chamber. The method further includes reducing, by gravity, an average size of the water particles of the aerosol to 5 μm or less as the aerosol goes from the lower region of the ultrasonic chamber to an upper region of the ultrasonic chamber across a vertical distance above a pre-determined threshold value. The method further includes transferring the aerosol to a collection chamber by a fan. The collection chamber is configured to be in fluid communication with the upper region of the ultrasonic chamber. The method further includes condensing the water particles in the aerosol to form a liquid water that has a lower salt concentration than the saline water.

In some embodiments, the method includes determining the pre-determined threshold value for reducing the average size of the water particles of the aerosol to 5 μm or less.

In some embodiment, the water particles in the aerosol are condensed to form the liquid water with no additional separation process to remove salts from the water particles before the water particles condense to form the liquid water.

In some embodiments, the additional separation process includes an energy input of heat, vortex or electrical charges.

In some embodiments, the method includes turning the ultrasonic transducers off to stop the generation of aerosol of the saline water. However, the fan is kept in operational state to prevent any the entrance of aerosol particles larger than 5 μm into the collection chamber. Furthermore, the method comprises detachment of the collection chamber from the desalination system.

In another embodiment, the size of the aerosol particles is further reduced to 2.5 μm by virtue of gravity as the particles travel vertically in the desalination system. The collection chamber may be positioned on the upper region of the ultrasonic chamber or on the side of the upper region of the ultrasonic chamber.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a pictorial representation of a desalination system, according to certain embodiments;

FIG. 2 is a schematic block diagram of the desalination system of FIG. 1, according to certain embodiments;

FIG. 3 is a graphical representation showing a relation between salinity of saline water and a droplet size of the saline water, according to certain embodiments;

FIG. 4 is a schematic diagram of a first prototype design of a desalination system, according to certain embodiments;

FIG. 5 is a schematic diagram of a second prototype of a desalination system, according to certain embodiments;

FIG. 6 is a schematic diagram of a third prototype of a desalination system, according to certain embodiments;

FIG. 7 is an exemplary illustration of a fourth prototype of a desalination system, according to certain embodiments;

FIG. 8 is a graphical representation depicting a comparison of salinity of the saline water and produced water based on the fourth prototype design of the desalination system of FIG. 7, according to certain embodiments;

FIG. 9 is a schematic diagram of a fifth prototype design of a desalination system, according to certain embodiments;

FIG. 10 is a graphical representation depicting a comparison of salinity of the saline water and produced water based on the fifth prototype design of the desalination system of FIG. 9, according to certain embodiments;

FIG. 11 is an exemplary flowchart of a method of desalination of water using the desalination system of FIG. 1, according to certain embodiments; and

FIG. 12 is a graphical representation showing a relation between salinity of saline water and a droplet size of the saline water, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a desalination system and a method for desalination of saline water. The desalination system described in the present disclosure employs high-frequency ultrasound energy to aerosolize saline water, thereby to separate the water molecules from the salt particles or total dissolved solids. The resulting aerosolized water particles have a reduced salt concentration when compared to the saline water.

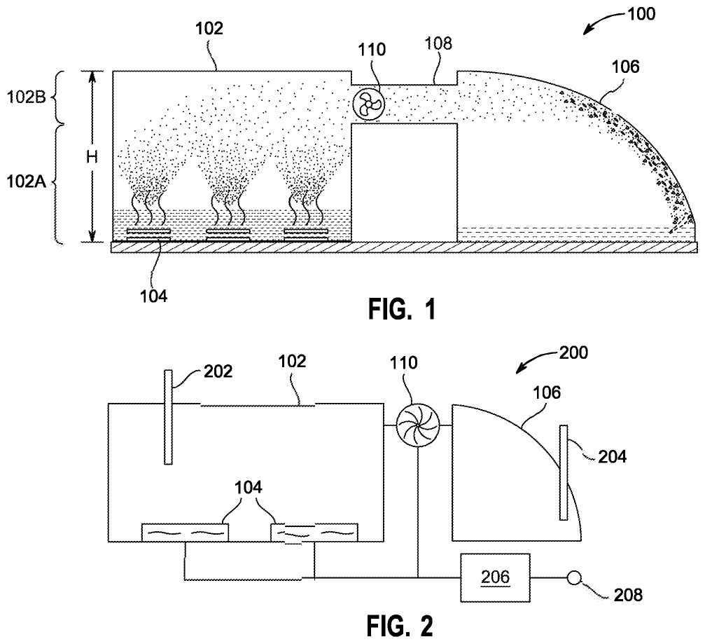

Referring to FIG. 1, a pictorial representation of a desalination system 100 is illustrated, according to an embodiment of the present disclosure. The desalination system 100 includes an ultrasonic chamber 102 configured to receive and store saline water therein. The ultrasonic chamber 102 may be a closed container having an inlet opening configured to receive the saline water therethrough and an outlet opening configured to fluidly communicate with an external device. The ultrasonic chamber 102 has a height ‘H’ defined by a lower region 102A and an upper region 102B. The inlet opening and the outlet opening may be defined in the upper region 102B of the ultrasonic chamber 102. The lower region 102A, otherwise referred to as a bottom portion, of the ultrasonic chamber 102 is configured to receive the saline water through the inlet opening and store the saline water therein. The upper region 102B, otherwise referred to as a top portion, of the ultrasonic chamber 102 is defined immediately above the lower region 102A and is configured to fluidly communicate with a source of the saline water and the external device. The upper and lower regions preferably define a single compartment having an open and unobstructed volume. The lower region 102A and the upper region 102B of the ultrasonic chamber 102 together define a vertical distance. In one embodiment, the vertical distance may be equal to the height ‘H’ of the ultrasonic chamber 102. In another embodiment, the vertical distance may be less than the height ‘H’ of the ultrasonic chamber 102.

The desalination system 100 further includes an ultrasonic transducer 104 located in the lower region 102A of the ultrasonic chamber 102. Particularly, the ultrasonic transducer 104 is submerged in the saline water stored in the lower region 102A of the ultrasonic chamber 102. The ultrasonic transducer 104 is configured to generate an aerosol including water particles from the saline water.

The desalination system 100 further includes a collection chamber 106 having an inlet opening and an outlet opening. The collection chamber 106 may be a closed container having the inlet opening defined at an upper region and the outlet opening defined at a lower region thereof. The inlet opening of the collection chamber 106 may be configured to fluidly communicate with the outlet opening of the ultrasonic chamber 102 via a conduit 108. As such, the conduit 108 is configured to connect the upper region 102B of the ultrasonic chamber 102 to the upper region of the collection chamber 106. In one embodiment, the collection chamber 106 is detachable from the ultrasonic chamber 102. Particularly, the collection chamber 106 may be attached to the ultrasonic chamber 102 through the conduit 108 using fastening members. The outlet opening of the collection chamber 106 may be configured to discharge water collected therein to an external container. As such, the collection chamber 106 is configured to be in fluid communication with the upper region 102B of the ultrasonic chamber 102. The desalination system 100 further includes a fan 110 disposed at the outlet opening. In some embodiments, the fan 110 may be disposed in the inlet opening of the collection chamber 106. In some embodiments, the fan may be disposed in the conduit 108. The fan 110 is configured to transfer the aerosol from the upper region 102B of the ultrasonic chamber 102 to the collection chamber 106.

In one embodiment the ultrasonic chamber 102 is connected to the collection chamber 106 through the conduit 108 and a helical fan (e.g. 110) with blades having a length of at least 90% the length of the conduit functions to transfer aerosolized water particles from the ultrasonic chamber 102 to the collection chamber 106. The blades of the helical fan are preferably configured to traverse less than one full turn radially in the conduit, more preferably less than ½ full turn and preferably travel helically along the axis of the cylindrical pathway by 10-30° when measured radially along a cross section of the cylindrical pathway.

Referring to FIG. 2, a schematic block diagram depicting an experimental set up of the desalination system 100 of FIG. 1 is illustrated, according to an embodiment of the present disclosure. In an embodiment, a desalination system 200 may be implemented near sea water sources. In accordance with the present disclosure, as shown in FIG. 2, the desalination system 200 includes the ultrasonic transducer 104 disposed within the lower region 102A of the ultrasonic chamber 102, which is configured to receive the saline water in the lower region thereof. In an embodiment, the desalination system 200 may include one or more transducers disposed within the lower region 102A of the ultrasonic chamber 102. The number of ultrasonic transducers may be decided based on various design parameters such as, but are not limited to, capacity of the ultrasonic chamber 102, type of the desalination system 200, and application of the desalination system 200. In some embodiments, the one or more ultrasonic transducers may be detachably placed on a base plate of the ultrasonic chamber 102 using fastening members. In some embodiments, the one or more ultrasonic transducers may be detachably attached to the base plate using a coupling mechanism known in the art.

The ultrasonic transducer 104 is configured to vibrate at a pre-defined frequency as per an input current and emits sound waves. The pre-defined frequency can be in a range of 1 kHz-3 MHz, preferably 10 kHz-2 MHz, preferably 25 kHz-500 kHz. The sound waves created by the ultrasonic transducer 104 travel through the saline water stored in the ultrasonic chamber 102. The sound waves vibrate the saline water and aerosolizes the saline water into minuscule particles and generate an aerosol due acoustic cavitation and streaming. The saline water is generally defined as a water that contains high concentration of salt. In general, acoustic cavitation is defined as the growth and collapse of micro-bubbles in a fluid due to ultrasonic waves.

In an embodiment, the desalination system 200 further includes a first salinity meter 202 disposed within the ultrasonic chamber 102 and a second salinity meter 204 disposed within the collection chamber 106. The first salinity meter 202 is configured to measure the salinity of the saline water stored in the lower region 102A of the ultrasonic chamber 102. The second salinity meter 204 is configured to measure salinity of water collected in the collection chamber 106, which is alternatively referred to as the produced water. The produced water refers to the processed water with low salinity collected in the collection chamber 106 from the ultrasonic chamber 102 using the ultrasonic desalination process of the present disclosure. In some embodiments, each of the first and the second salinity meters 202, 204 may include probes that check for electrical conductivity in the water. The electrical conductivity is affected by the ions present in the saline water. In one example, salinity values measured by the first and the second salinity meters readings may be recorded by an operator for testing and analysis purposes. In another example, the first and second salinity meters 202, 204 may be in electric communication with a controller which in turn may determine the salinity values of the saline water and the produced water.

The desalination system 100 includes the fan 110 that is configured to transfer the aerosol generated by the one or more ultrasonic transducers from the upper region 102B of the ultrasonic chamber 102 to the collection chamber 106 via the conduit 108. The conduit 108 is near or at a top of the upper region 102B. The position of the conduit 108 is not limited as long as a distance between a top surface of the stored water in the lower region 102A and a bottom of the conduit 108 is sufficient for the average size of the water particles of the aerosol to be reduced by gravity to 5 μm or less in the conduit 108. A length of the conduit 108 is not limited as long as the fan 110 can be installed there. The length of the conduit 108 is preferably 3 times, preferably 2 times, preferably 1.5 times, of a length of the fan 110. While shown to have a leveled bottom surface in FIG. 1, the conduit 108 can have a slanted bottom surface, especially when the conduit 110 is longer than 2 times of the length of the fan 110. The slanted bottom surface can have a lower end towards the collection chamber 103 so that water vapors which condense in the conduit 108 will flow along the slanted bottom surface into the collection chamber 103, instead of flowing back to the ultrasonic chamber 102. The fan 110 is configured to continue operation after the ultrasonic transducer 104 is turned off to prevent water particles with an average size of larger than 5 micrometers (μm) (more preferably no larger than 4.5 μm, 4 μm, 3.5 μm, 3 μm or 2.5 μm) from entering the collection chamber 106.

The vertical distance defined by the lower region 102A and the upper region 102B of the ultrasonic chamber 102 is above a pre-determined threshold value so that an average size of the water particles of the aerosol is reduced by gravity to 5 μm or less. The pre-determined threshold value refers to a minimum height of the ultrasonic chamber 102 measured with respect to the base of the ultrasonic chamber 102. The minimum height of the ultrasonic chamber 102 may be defined based on various parameters such as, but are not limited to, a gravitational force acting on the water particles, size of the water particles, and density of the saline water. In an embodiment, the minimum height of the ultrasonic chamber 102 may be defined by the lower region 102A of the ultrasonic chamber 102 while the upper region 102B of the ultrasonic chamber 102 may be defined above the minimum height of the ultrasonic chamber 102 such that the average size of the water particles of the aerosol is reduced by gravity to 5 μm or less in the upper region 102B of the ultrasonic chamber 102. In one embodiment, the minimum height of the ultrasonic chamber 102 may be defined in order to maintain a minimum distance between a top surface of the stored water in the lower region 102A and a bottom of the conduit 108 as required for the average size of the water particles of the aerosol to be reduced by gravity to 5 μm or less in the conduit 108. In some embodiments, the lower region 102A of the ultrasonic chamber 102 and the upper region 102B of the ultrasonic chamber 102 are configured so that, in the upper region 102B of the ultrasonic chamber 102, the average size of the water particles of the aerosol is reduced by gravity to 2.5 μm or less. The aerosol including the water particles with the size equal to 5 μm or less than 5 μm is sucked due to the air flow created by the fan 110. In an embodiment, the fan 110 may be waterproof in nature and may handle rigorous continued operation without presenting operational defects.

Note that the (minimum) height of the ultrasonic chamber 102 is not limited and may depend on the frequency of the ultrasonic transducer 104, the temperature of the stored water, the salinity of the stored water, etc. Similarly, a relative ratio of the height of the lower region 102A to the height of the upper region 102B may depend on specific design needs and can for example be in a range of 1:5 to 5:1, preferably 1:4 to 4:1, preferably 1:3 to 3:1, preferably 1:2 to 2:1.

In the example of FIG. 1, the lower region 102A and the upper region 102B of the ultrasonic chamber 102 are fixedly connected to each other. In other examples (not shown), the lower region 102A and the upper region 102B of the ultrasonic chamber 102 can be slidably connected to each other in order to adjust the height of the ultrasonic chamber 102 so as to provide flexible control over the duration of the gravitational force acting on the water particles, the size of the water particles in the upper region 102B, and thus the salinity thereof. One advantage of such a design is to save space for a small height of the ultrasonic chamber 102 when possible while being able to accommodate a large height of the ultrasonic chamber 102 when needed.

The desalination system 100 includes the collection chamber 106 having a dome-shaped structure. The collection chamber 106 is configured to be in fluid communication with the upper region 102B of the ultrasonic chamber 102 to receive the aerosol discharged by the fan 110. In the collection chamber 106, the water particles in the aerosol are configured to condense to form liquid water. Particularly, the collection chamber 106 facilitates condensation of the aerosolized water particles coming from the ultrasonic chamber 102. The liquid water, alternatively referred to as the produced water, collected in the collection chamber 106 has a lower salt concentration than the saline water stored in the ultrasonic chamber 102.

In some embodiments, the water particles in the aerosol are configured to condense to form the liquid water in the collection chamber 106 preferably with no additional separation process to remove salts from the water particles before the water particles condense to form the liquid water. In some embodiments, the desalination system 100 includes an additional separation process to remove salts from the water particles before the water particles condense to form the liquid water. The additional separation process includes, but are not limited to, an energy input of heat, vortex or electrical charges. Energy input of heat may be defined as input of thermal energy into a system including saline water. In the thermal desalination process, the heat input generates steam from the saline water present in the system. The steam has lower concentration of salt as compared to the saline water. The vortex may be defined as generation of a controlled, wind-powered vortex of air in a tower located over a supply of saline water. The spinning column of air creates a region of negative pressure over the salt water which causes fresh water to cavitate and migrate up the tower to a freshwater collector. Further, the electrical charges may be defined as electrodialysis desalination. The electrodialysis desalination uses electric fields to pull salt ions out of saline water. The electrodialysis desalination uses semi-permeable membranes to separate the desalinated water from the concentrated brine on the other side of the semi permeable membrane. According to the present disclosure, the desalination system 100 is configured to produce the liquid water, present in the collection chamber 106, having a lower salt concentration than the saline water present in the ultrasonic chamber 102. In an embodiment, the liquid water has a salt concentration of at least 60% lower than the saline water.

In one embodiment, the collection chamber 106 is positioned above the upper region 102B of the ultrasonic chamber 102. More specifically, a volume defined by the collection chamber 106 may be entirely positioned above the upper region 102B of the ultrasonic chamber 102 vertically. In some embodiments, the volume defined by the collection chamber 106 may be entirely positioned above the upper region 102B of the ultrasonic chamber 102 at an offset distance from the ultrasonic chamber 102. In some embodiments, the ultrasonic chamber 102 has a slanted top having a lower end towards the collection chamber 106. More specifically, the collection chamber 106 may be positioned parallel to the ultrasonic chamber 102 near the upper region thereof. In an embodiment, the upper region 102B of the collection chamber 106 is dome-shaped so that the water particles in the aerosol are forced to condense to form the liquid water by impingement on the upper region 102B of the collection chamber 106.

The desalination system further includes a controller 206 configured to be in electric communication with the one or more ultrasonic transducers. The controller 206 is further coupled to a power supply 208 for receiving electric power therefrom to supply current to the plurality of ultrasonic transducers at a desired ampere and voltage. In some embodiments, the controller 206 may be communicated with the fan 110 to control operation thereof. The controller 206 may be configured to continue the operation of the fan 110 after the one or more ultrasonic transducers are turned off. In an embodiment, the controller 206 may be in the form of a circuit board which may have safety features to ensure safety of the desalination system 200. Further, the circuit board may be modular in nature and may have circuit breakers to prevent short circuit in emergency situations. The power supply 208 may be an alternating current (AC) that ensures the continuous flow of electricity to the desalination system 200.

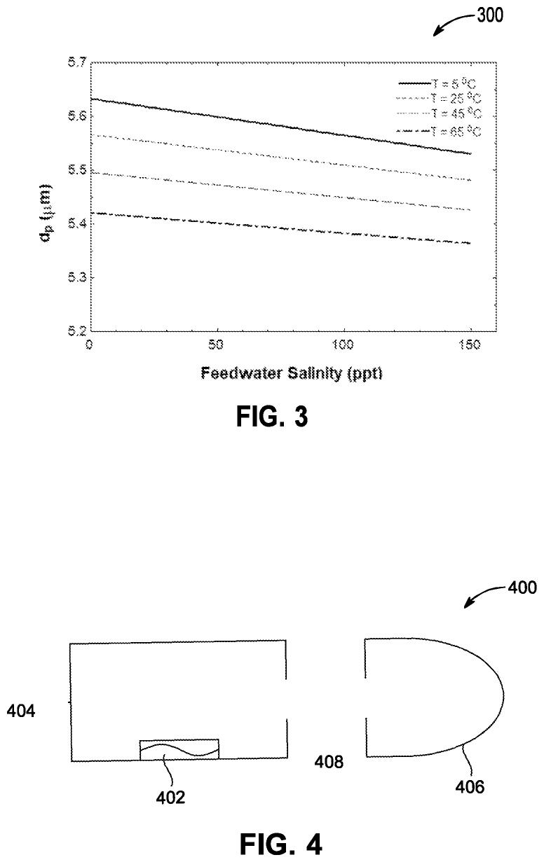

According to the present disclosure, the ultrasonic desalination process will decrease the salinity of water by a certain percentage in each pass depending on the initial salinity of the saline water being used. The process can be used with typical reverse osmosis (RO) plants as a pre-processing of the saline water. The process when used with the thermal desalination systems can enhance the rate of evaporation that will generate more distilled water. The size of the droplets formed by the ultrasonic transducer 104 determines how much salt the water carries with it. The size of droplet not only depends on the frequency of the ultrasound waves but also on the quality of water (temperature and salinity). The relation between the saline water salinity (parts per thousands) and the droplet size at three different temperatures (20, 50 and 90 degree Celsius (C)) for a fixed frequency of ultrasound (17 MHz) is shown in FIG. 3.

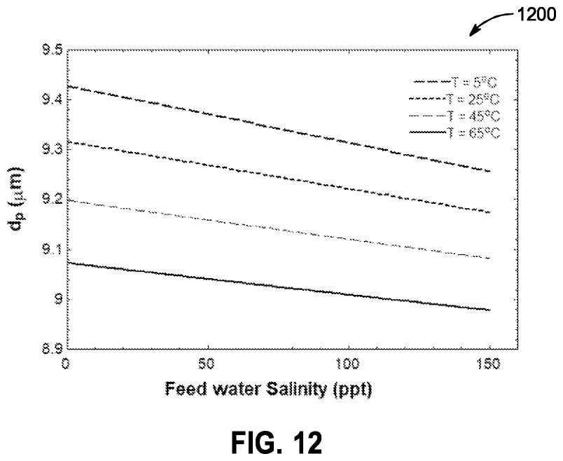

Referring to FIG. 3, a graphical representation showing a relation between the salinity of the water and the median droplet size of the water is illustrated for a fixed frequency of ultrasonic waves at 1.7 MHz, according to an embodiment of the present disclosure. A graph 300 depicts the median droplet size of the water particles on y-axis and the salinity on x-axis. The size of the water particles is measured in micrometers and the salinity is measured in parts per thousand. The relation between the salinity of water and the droplet size is plotted at four temperatures, 5° C., 25° C., 45° C. and 65° C. for the fixed frequency of ultrasonic waves at 1.7 MHz representing the frequency of the ultrasonic humidifier used in the desalination experiment. It can be noted from the curve of the graph 300 that at 1.7 MHz frequency also, the salinity of the water and its temperature have negligible effect on the size of the droplets produced in the ultrasonic humidifier. However, FIG. 3 and FIG. 12 taken together show that the size of the water droplets and frequency of ultrasonic waves have an inverse relationship, and the larger the frequency of ultrasonic waves is, the smaller is the resulting median droplet size.

Referring to FIG. 12, a graphical representation showing a relation between the salinity of the water and the median droplet size of the water is illustrated for a fixed frequency of ultrasonic waves at 105 kHz, according to an embodiment of the present disclosure. A graph 1200 depicts the median droplet size of the water particles on y-axis and the salinity on x-axis. The size of the water particles is measured in micrometers and the salinity is measured in parts per thousand. The relation between the salinity of water and the droplet size is plotted at four temperatures, 5° C., 25° C., 45° C. and 65° C. for the fixed frequency of ultrasonic waves at 105 kHz. It can be noted from the graph 1200 that the salinity of the water droplets and its temperature have a negligible effect on the size of the water droplets produced in the ultrasonic humidifier.

Table 1 below shows an example of experimental conditions and is not limiting.

TABLE 1
Experimental Conditions

Room Conditions:
Room Temperature: 24° C.
Feed Water Conditions:
Water Temperature: 20° C. (initial)
Salinity: varies from about 1200 ppm to 18000 ppm
Source: Tap water with added salts
Ultrasonic Humidifier Specifications (Used in Designs 4 and 5):
Number of humidifiers: 12 heads
Brand: SEEAN
Model Number DE23
Material: 304 stainless steel fog machine
Dimensions: 39.6 × 18.5 × 16.1 cm
Weight: 4.2 kg
Frequency: 1.7 MHz

### EXAMPLES

Various prototypes were tested. Referring to FIG. 4, a schematic diagram of a first prototype design of a desalination system 400 is illustrated, according to an embodiment of the present disclosure. The first prototype design of the desalination system 400 includes an ultrasonic transducer 402 disposed within an ultrasonic chamber 404. The ultrasonic chamber 404 is further fluidly coupled with a collection chamber 406 via a conduit 408. The collection chamber 406 has a dome shape to facilitate condensing of the water particles in the aerosol to form ta liquid water. The ultrasonic chamber 404 and the collection chamber 406 are at the same level. Particularly, a height of the ultrasonic chamber 404 is equal to a height of the collection chamber 406 and the collection chamber 406 is positioned on a side of the ultrasonic chamber 404.

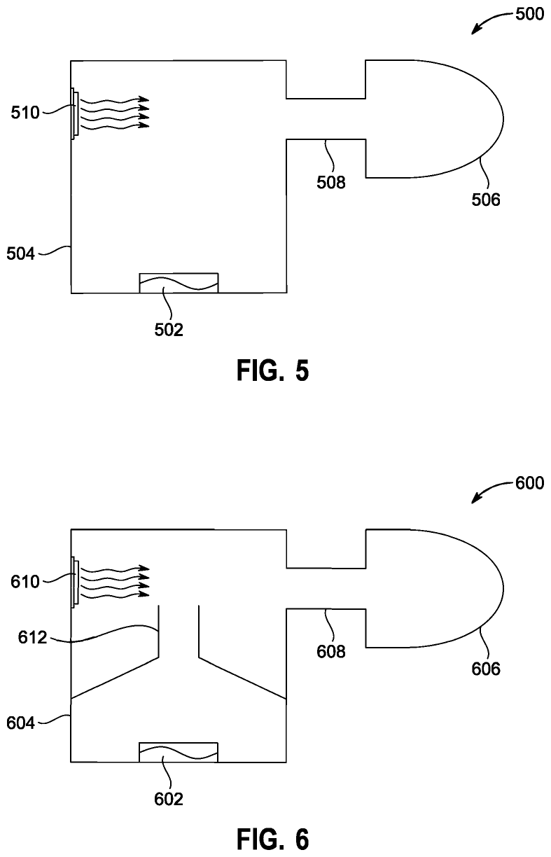

Referring to FIG. 5, a schematic diagram of a second prototype design of a desalination system 500 is illustrated, according to an embodiment of the present disclosure. The second prototype design of the desalination system 500 includes an ultrasonic transducer 502 disposed within an ultrasonic chamber 504. The ultrasonic chamber 504 is further fluidly coupled with a collection chamber 506 via a conduit 508. The collection chamber 506 has a dome shape to facilitate condensing of the water particles in the aerosol to form ta liquid water. The second prototype design of the desalination system 500 includes the collection chamber 506 positioned at a pre-defined height with respect to a height of the ultrasonic chamber 504. Particularly, the height of the ultrasonic chamber 504 is greater than a height of the collection chamber 506, and the collection chamber 506 is positioned on a side of the ultrasonic chamber 504. The second prototype design of the desalination system 500 includes a fan 510 disposed at a side wall of the ultrasonic chamber 504, opposite to the side wall the conduit 508 is connected. The fan 510 is configured to push the aerosol produced in the ultrasonic chamber 504 into the collection chamber 506.

Referring to FIG. 6, a schematic diagram of a third prototype design of a desalination system 600 is illustrated, according to an embodiment of the present disclosure. The third prototype design of the desalination system 600 includes an ultrasonic transducer 602 disposed within an ultrasonic chamber 604. The ultrasonic chamber 604 is further fluidly coupled with a collection chamber 606 via a conduit 608. The collection chamber 606 has a dome shape to facilitate condensing of the water particles in the aerosol to form liquid water. A fan 610 is disposed at a side wall of the ultrasonic chamber 604, opposite to the side wall the conduit 608 is connected. The fan 610 is configured to push the aerosol produced in the ultrasonic chamber 604 into the collection chamber 606. The desalination system 600 further includes a funnel structure 612 disposed inside the ultrasonic chamber 604. The funnel structure 612 facilitates uniform and concentrated flow of the aerosol generated by the ultrasonic transducer 602. The fan 610 installed at the side wall of the ultrasonic chamber 604 pushes the aerosol coming up from the funnel structure 612 into the collection chamber 606.

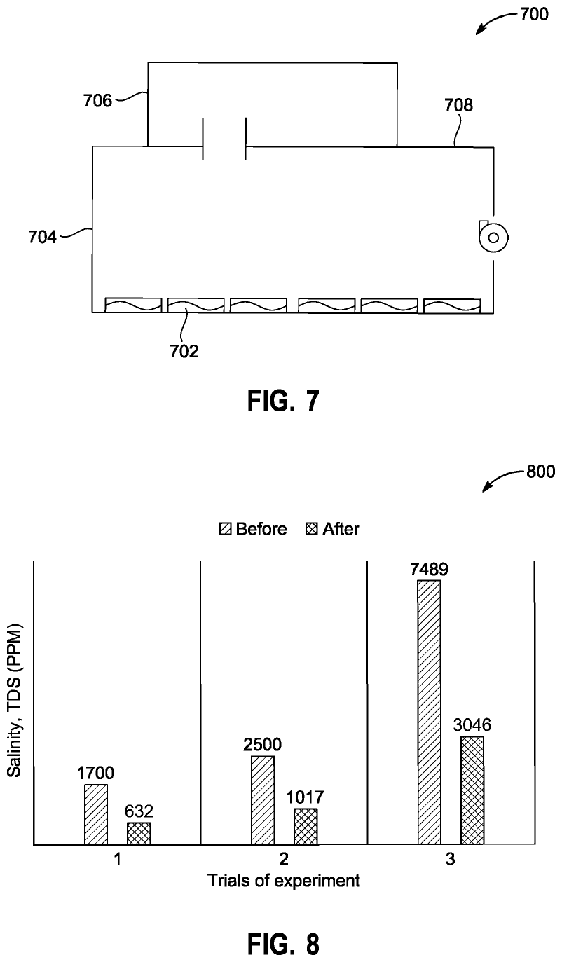

Referring to FIG. 7, a schematic diagram of a fourth prototype design of a desalination system 700 is illustrated, according to an embodiment of the present disclosure. The fourth prototype design of the desalination system 700 includes an ultrasonic transducer 702 disposed within an ultrasonic chamber 704. The ultrasonic chamber 704 is further fluidly coupled with a collection chamber 706. Particularly, the collection chamber 706 is configured to be positioned adjacent to a top wall 708 of the ultrasonic chamber 704. An opening is defined in the top wall 708 to fluidly communicate the collection chamber 706 with the ultrasonic chamber 704. A gateway is provided between the ultrasonic chamber 704 and the collection chamber 706.

The results of different trials at various feedwater salinity are shown in FIG. 8 for the fourth prototype design of the desalination system 700. The feedwater salinity was varied between 1700 to 7489 parts per million (ppm) and an average salinity reduction of 60% was achieved. Referring to FIG. 8, an exemplary bar graph 800 is illustrated, depicting the comparison of the salinity of the saline water and the produced water using the desalination system 700. As can be observed from the bar graph, the salinity of the produced water is lower than the salinity of the saline water. In an example, when the salinity of the saline water is 1,700 ppm, the salinity of the produced water after undergoing ultrasonic desalination process is recorded to be 632 ppm. In another example, when the salinity of the saline water is 2,500 ppm, the salinity of the produced water after undergoing ultrasonic desalination process is recorded to be 1,017 ppm. In yet another example, when the salinity of the saline water is 7,489 ppm, the salinity of the produced water after undergoing ultrasonic desalination process is recorded to be 3,046 ppm. Thus, the average salinity reduction of 60% is achieved with the desalination system 700.

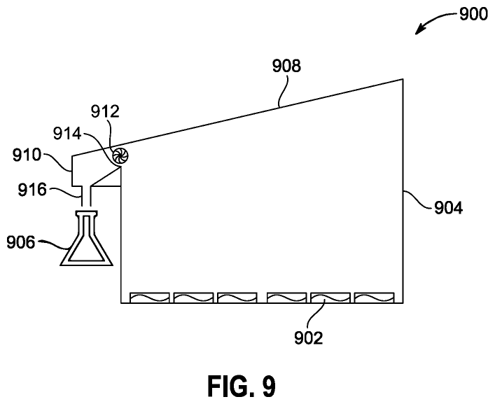

Referring to FIG. 9, a schematic diagram of a fifth prototype design of a desalination system 900 is illustrated, according to an embodiment of the present disclosure. The fifth prototype design of the desalination system 900 is an efficient realization of the desalination system 100. The fifth prototype design of the desalination system 900 includes an ultrasonic transducer 902 disposed within an ultrasonic chamber 904 and a collection chamber 906 configured to be disposed adjacent a side wall of the ultrasonic chamber 904. The ultrasonic chamber 904 has a slanted top 908 having a lower end 910 positioned towards the collection chamber 906. The slanted top 908 may facilitate movement of the aerosol towards the lower end 910 thereof due to the gravity. In some embodiments, a fan 912 may be disposed within a passage 914 defined by the ultrasonic chamber 904 to exit the aerosol produced by the ultrasonic transducer 902. In some embodiments, the collection chamber 906 may fluidly communicate with a conduit 916.

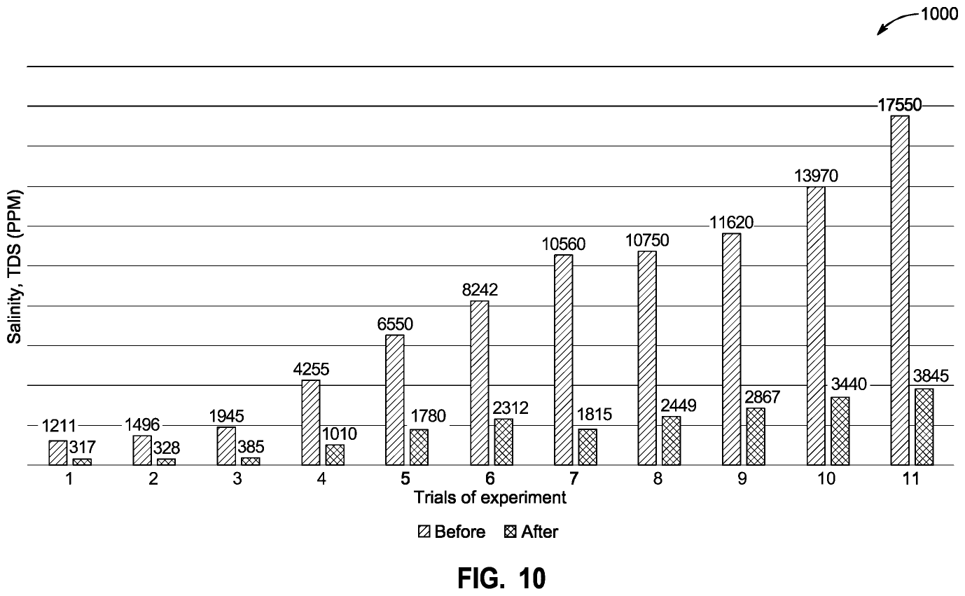

Compared to the fourth prototype design of the desalination system 700, further reduction in salinity with an average reduction of 76.5% was achieved by the fifth prototype design of the desalination system 900. Particularly, design and position of the collection chamber 906 is altered to improve the flow of aerosol towards the lower end 910 of the slanted top 908. The salinity data collected for the fifth prototype design of the desalination system 900 is shown in FIG. 10. The feedwater salinity was varied between 1200 to 18000 ppm.

Referring to FIG. 10, an exemplary bar graph 1000 is illustrated, depicting the comparison of the salinity of saline water and the produced water using the fifth prototype design of the desalination system 900. As can be observed from the bar graph 1000, the salinity of the produced water is consistently lower than that of the saline water. In an example, when the salinity of the saline water is 1,211 ppm, the salinity of the produced water after undergoing ultrasonic desalination process is recorded to be 317 ppm. In another example, when the salinity of the saline water is 1,496 ppm, the salinity of the produced water after undergoing ultrasonic desalination process is recorded to be 328 ppm. In yet another example, when the salinity of the saline water is 1,945 ppm, the salinity of the produced water after undergoing ultrasonic desalination process is recorded to be 385 ppm. In yet another example, when the salinity of the saline water is 4,255 ppm, the salinity of the produced water after undergoing ultrasonic desalination process is recorded to be 1,010 ppm. In yet another example, when the salinity of the saline water is 6,550 ppm the salinity of the produced water after undergoing ultrasonic desalination process is recorded to be 1,780 ppm. In yet another example, when the salinity of the saline water is 8,242 ppm, the salinity of the produced water after undergoing ultrasonic desalination process is recorded to be 2,312 ppm. In yet another example, when the salinity of the saline water is 10,560 ppm, the salinity of the produced water after undergoing ultrasonic desalination process is recorded to be 1,815 ppm. In yet another example, when the salinity of the saline water is 10,750 ppm, the salinity of the produced water after undergoing ultrasonic desalination process is recorded to be 2,449 ppm. In yet another example, when the salinity of the saline water is 11,620 ppm, the salinity of the produced water after undergoing ultrasonic desalination process is recorded to be 2,867 ppm. In yet another example, when the salinity of the saline water is 13,970 ppm, the salinity of the produced water after undergoing ultrasonic desalination process is recorded to be 3,440 ppm. In yet another example, when the salinity of the saline water is 17,550 ppm, the salinity of the produced water after undergoing ultrasonic desalination process is recorded to be 3,845 ppm. Thus, an average reduction of 76.5% is observed in the salinity of the produced water.

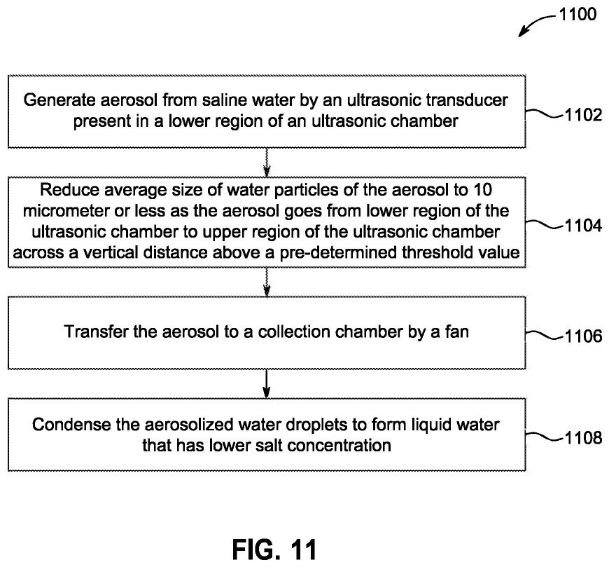

Referring to FIG. 11, a method 1100 for desalination of water using the desalination system 100 is illustrated, according to an embodiment of the present disclosure. The order in which the method 1100 is described is not intended to be construed as a limitation, and any number of the described method steps may be combined in any order to implement the method 1100. Additionally, individual steps may be removed or skipped from the method 1100 without departing from the spirit and scope of the present disclosure. The method 1100 of the present disclosure is illustrated with reference to the desalination system 100 shown in FIG. 1 and FIG. 2.

At step 1102, the method 1100 includes generating the aerosol from the saline water by the ultrasonic transducer 104 located in the lower region 102A of the ultrasonic chamber 102 of the desalination system 100. The aerosol includes water particles. In other words, the aerosol is defined as a mist of minuscule water particles. One or more ultrasonic transducers are disposed within the lower region 102A of the ultrasonic chamber 102. The controller 206 in communication with the ultrasonic transducer 104 supplies current to the ultrasonic transducer 104 from the power supply 208 at the desired ampere and voltage. Such that the ultrasonic transducer 104 located in the lower region 102A of the ultrasonic chamber 102 aerosolizes the saline water present in the ultrasonic chamber 102 by acoustic cavitation and streaming. The salinity of the saline water is measured by the first salinity meter 202.

At step 1104, the method 1100 includes reducing the average size of the water particles of the aerosol to 4 μm or less. The reduction of the size of the water particles takes place due to gravity separation. As larger and heavy droplets settle down at the lower region 102A of the ultrasonic chamber 102, water particles of 4 μm or less travels to the upper region 102B of the ultrasonic chamber 102. As the vertical distance defined by the lower region 102A of the ultrasonic chamber 102 and the upper region 102B of the ultrasonic chamber 102 is above the pre-determined threshold value, the average size of the water particles of the aerosol is reduced to 4 μm or less due to the gravity as the aerosol goes from the lower region 102A of the ultrasonic chamber 102 to the upper region 102B of the ultrasonic chamber 102. In some embodiments, the method 1100 includes determining the pre-determined threshold value for reducing the average size of the water particles of the aerosol to 5 μm or less, preferably 4 μm or less, preferably 3 μm or less, preferably 2 μm or less.

At step 1106, the method 1100 includes transferring the aerosol from the ultrasonic chamber 102 to the collection chamber 106 by the fan 110. The collection chamber 106 disposed to be in fluid communication with the ultrasonic chamber 102 using the conduit 108. In some embodiments, the collection chamber 106 is positioned above the upper region 102B of the ultrasonic chamber 102 or on the side of the upper region 102B of the ultrasonic chamber 102. The fan 110 disposed in the conduit 108 sucks the aerosol from the ultrasonic chamber 102 and transfers the aerosol to the collection chamber 106. In some embodiments, the method 1100 includes turning off the ultrasonic transducer 104 to stop generating the aerosol while operating the fan 110 to prevent water particles with the average size of larger than 5 μm from entering the collection chamber 106.

At step 1108, the method 1100 includes condensing the water particles in the aerosol to form the liquid water that has the lower salt concentration than the saline water. According to the present disclosure, the dome shape of the collection chamber 106 facilitates the condensation process more efficient. The condensed liquid water from the aerosol is stored in the collection chamber 106. The condensed liquid water has low salinity as measured by the second salinity meter 204. In some embodiments, the water particles in the aerosol are condensed to form the liquid water with no additional separation process to remove salts from the water particles before the water particles condense to form the liquid water. In some embodiments, the additional separation process including the energy input of heat, the vortex or the electrical charges may be attached to the desalination system 100 to remove salts from the water particles before the water particles condense to form the liquid water. The method 1100 further includes turning off the ultrasonic transducer 104 to stop generating the aerosol and detaching the collection chamber 106 from the ultrasonic chamber 102.

According to the present disclosure, the desalination system 100 is compact in size and modular in nature. The compact size of the desalination system 100 makes for easy transportation. The small footprint of the desalination system 100 is ideal for employment in any current desalination or water purification plants. The aerosol produced by the desalination system 100 is ideal, due the large surface area of the aerosolized water droplets, to be used as a precursor for any thermal energy-based desalination or water purification systems. The integration of the desalination system 100 into existing water purification plants is simple due to the modular nature of the desalination system 100. The desalination system 100 may be employed in water procession plants which need quick up sizing due to the demand. The desalination system 100 also does not generate chemical waste.

Further, the desalination system 100 may be energy-efficient. Since the desalination process relies on the use of high-frequency sound waves and gravity to remove salt and other minerals from seawater, the energy consumption is relatively low. The lower energy consumption of the desalination system 100 makes for a sustainable option for producing fresh water from seawater. The desalination system 100 may be suitable for use in areas with limited access to electricity or other forms of energy. However, it is important to note that the energy efficiency of the desalination system 100 may vary depending on the specific system and operating conditions. Factors that may affect the energy efficiency of the desalination system 100 include, but may not be limited to, the size and design of the different desalination system 100, the quality of the incoming seawater, and the ambient temperature.

Numerous modifications and variations of the present disclosure are possible in light of the above teachings. It is therefore to be understood that within the scope of the appended claims, the invention may be practiced otherwise than as specifically described herein.

1. A desalination system, comprising:
an ultrasonic chamber configured to receive saline water in a lower region of the ultrasonic chamber;
an ultrasonic transducer located in the lower region of the ultrasonic chamber and configured to generate an aerosol comprising water particles from the saline water;
a collection chamber configured to be in fluid communication with an upper region of the ultrasonic chamber; and
a fan configured to transfer the aerosol from the upper region of the ultrasonic chamber to the collection chamber,
wherein the lower region of the ultrasonic chamber and the upper region of the ultrasonic chamber have a vertical distance above a pre-determined threshold value so that, in the upper region of the ultrasonic chamber, an average size of the water particles of the aerosol is reduced by gravity to 5 μm or less, and
wherein the collection chamber is configured such that water particles in the aerosol condense to form liquid water in the collection chamber, and the liquid water has a lower salt concentration than the saline water.

2. The desalination system of claim 1, wherein the water particles in the aerosol are configured to condense to form the liquid water, which is collected by the collection chamber, with no additional separation process to remove salts from the water particles before the water particles condense to form the liquid water.

3. The desalination system of claim 2, wherein the additional separation process comprises an energy input of heat, vortex or electrical charges.

4. The desalination system of claim 1, wherein the fan is configured to continue operation, after the ultrasonic transducer is turned off, to prevent water particles with an average size of larger than 5 μm from entering the collection chamber.

5. The desalination system of claim 1, wherein the collection chamber is positioned above the upper region of the ultrasonic chamber.

6. The desalination system of claim 1, wherein the collection chamber is positioned on a side of the upper region of the ultrasonic chamber.

7. The desalination system of claim 1, wherein the ultrasonic chamber has a slanted top having a lower end towards the collection chamber.

8. The desalination system of claim 1, wherein the upper region of the collection chamber is dome-shaped so that the water particles in the aerosol are configured to condense to form the liquid water on the upper region of the collection chamber.

9. The desalination system of claim 1, further comprising a conduit connecting the upper region of the ultrasonic chamber to the upper region of the collection chamber.

10. The desalination system of claim 1, wherein the collection chamber is detachable from the ultrasonic chamber.

11. The desalination system of claim 1, wherein the liquid water has a salt concentration at least 60% lower than the saline water.

12. The desalination system of claim 1, wherein the lower region of the ultrasonic chamber and the upper region of the ultrasonic chamber are configured so that, in the upper region of the ultrasonic chamber, the average size of the water particles of the aerosol is reduced by gravity to 2.5 μm or less.

13. A method of water desalination, comprising:
generating an aerosol from saline water by an ultrasonic transducer located in a lower region of an ultrasonic chamber, wherein the aerosol comprises water particles;
reducing, by gravity, an average size of the water particles of the aerosol to 5 μm or less as the aerosol goes from the lower region of the ultrasonic chamber to an upper region of the ultrasonic chamber across a vertical distance above a pre-determined threshold value;
transferring the aerosol to a collection chamber by a fan, the collection chamber configured to be in fluid communication with the upper region of the ultrasonic chamber; and
condensing the water particles in the aerosol to form a liquid water that has a lower salt concentration than the saline water.

14. The method of claim 13, further comprising determining the pre-determined threshold value for reducing the average size of the water particles of the aerosol to 5 μm or less.

15. The method of claim 13, wherein the water particles in the aerosol are condensed to form the liquid water with no additional separation process to remove salts from the water particles before the water particles condense to form the liquid water.

16. The method of claim 15, wherein the additional separation process comprises an energy input of heat, vortex or electrical charges.

17. The method of claim 13, further comprising:
turning off the ultrasonic transducer to stop generating the aerosol; and
operating the fan to prevent water particles with an average size of larger than 5 μm from entering the collection chamber.

18. The method of claim 13, further comprising:
turning off the ultrasonic transducer to stop generating the aerosol; and
detaching the collection chamber from the ultrasonic chamber.

19. The method of claim 13, further comprising reducing, by gravity, the average size of the water particles of the aerosol to 2.5 μm or less as the aerosol goes across the vertical distance.

20. The method of claim 13, wherein the collection chamber is positioned above the upper region of the ultrasonic chamber or on a side of the upper region of the ultrasonic chamber.
